(19) United States
(12) Patent Application Publication
(10) Pub. No.: US 2022/0218101 A1
(43) Pub. Date: Jul. 14, 2022

(54) HAND HELD STUDIO AND BOOTH

(71) Applicant: Steven Michael Garcia, San Jose, CA (US)

(72) Inventor: Steven Michael Garcia, San Jose, CA (US)

(21) Appl. No.: 17/571,867

(22) Filed: Jan. 10, 2022

Related U.S. Application Data
(60) Provisional application No. 63/205,829, filed on Jan. 11, 2021.
(60) Provisional application No. 63/144,056, filed on Feb. 1, 2021.

(51) Int. Cl. A47B 19/04

(52) U.S. Cl. CPC A47B 19/04; A47B 19/002

(57) ABSTRACT

A hand held mobile studio and booth system includes a stick coupled with a universal mount to hold one or more components through one or more connectors. For example, the one or more components include one or more computing devices, a microphone, a noise protection filter to reduce popping sounds caused by fast moving air on the microphone, one or more electronic devices to allow dual transmission, and one or more reflection filters to reduce background noise by preventing sound waves reflection.

### RELATED APPLICATIONS

This application claims the benefit of U.S. provisional patent application No. 63/205,829, filed Jan. 11, 2021 and U.S. provisional patent application No. 63/144,056, filed Feb. 1, 2021, which are incorporated by reference in their entirety.

### FIELD OF THE INVENTION

Embodiments of the present invention relate generally to sound and audio production. More particularly, embodiments of the invention relate to hand held studio and booth.

### BACKGROUND

The art of producing studio quality sound on a mobile device has yet to be perfected with studio grade hardware. Current music studios are stationed at a permanent location with a Business Store Front etc. These studios since the beginning of modern music have all possess nothing but the High End Expensive Hardware and Equipment that was needed to produce music. On one end, professional A-grade recording systems are in immovable music studio buildings while home recording studios only contain a computer with music studio software.

Currently, app developers have adapted studio software to mobile devices such as cellphones or tablets to increase public accessibility. And yet, such software lacks professional studio quality hardware and recordings.

### BRIEF DESCRIPTION OF THE DRAWINGS

Embodiments of the invention are illustrated by way of example and not limitation in the figures of the accompanying drawings in which like references indicate similar elements.

FIG. 1 is a side view of an example of a hand held mobile studio and booth system according to an embodiment of the application.

FIG. 2 is another side view (microphone not shown) of an example of a hand held mobile studio and booth system according to an embodiment of the application.

FIG. 3 is a side view (microphone shield now shown) of an example of a hand held mobile studio and booth system according to an embodiment of the application.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

The present disclosure is in the field of “Sound and Audio Production” targeted towards independent hip-hop artists for mobile studio sound production; nonetheless applications for the present disclosure can be used for broadcasts, podcasts, streams, journalism or sing-along Karaoke.

The solution proposed in the current disclosure provides an advanced mobile studio experience and operation method for sound and audio recording.

The current disclosure has the following benefits: 1. High accessibility to the general public due to portability. 2. Affordable price. 3. Comprehensive recording.

The disclosure is versatile in carrying out functions such as karaoke parties, online broadcasting, streaming, podcasting, virtual meetings. Producers and artists are attracted to a comprehensive mobile recording studio for four reasons: 1. Higher access to studio sound recordings due to portable studio software equipment. 2. Ease of recording since the device's music software is attached to a hand-held booth. 3. Provides clarity and flexibility to the artist through easy vocal and sound adjustment mechanisms. 4. Bluetooth Transmitter dual signal transmission to two separate Bluetooth devices.

In addition, with a mobile studio, the public will be able to grow their passion, in turn allowing the music industry to grow and thrive. Further, with current studios either being inaccessible due to their price or localization to a store, a Hand-Held Mobile Studio and Booth is needed.

For example, the Hand-held Studio and Booth features a sleek and attractive exterior that integrates the necessities in a recording studio on a support handle. The Hand-Held Studio and Booth consists of the most updated and recent technology that allows artists to produce high quality studio recordings in a mobile comprehensive system. The Hand-Held Studio and Booth features a high-quality microphone shield, a condenser microphone, and pop-screen creating clear, and professional studio-quality sound.

The equipment allows recording to block out unwanted ambient sounds in a natural recording environment (i.e., Buses, trucks, background static, planes). Microphone shields and pop-screens isolate the vocals to create recordings that resemble professional studios.

The current disclosure provides artists with a time-efficient, unique, and accessible high-quality recording opportunity. The current disclosure incorporates necessary equipment in a compact fashion. The present disclosure is described in detail in the following examples, which may represent more than one embodiment of the present invention.

In an embodiment, a hand held mobile studio and booth system includes a stick coupled with a universal mount to hold one or more components through one or more connectors. For example, the one or more components include one or more computing devices, a microphone, a noise protection filter to reduce popping sounds caused by fast moving air on the microphone, one or more electronic devices to allow dual transmission, and one or more reflection filters to reduce background noise by preventing sound waves reflection.

In some embodiments, the stick is swayable for a variety angles to provide stability and balance to support the one or more components while the stick is held by a user. For example, an angle of the variety angles is adjustable by the user according to an embodiment of the application. Further, in some embodiments, the stick has a ball joint for a swivel action.

In some embodiments, the stick is extendable. In an embodiment, the stick is retractable. In other embodiments, the stick has a retractable tri-pod feature to allow the user to extend and transform into a microphone stand feature.

In some embodiments, the one or more electronic devices includes a Bluetooth transmitter to allow dual transmission to two or more devices including one or more of headset and speaker.

In some embodiments, the noise protection filter is a pop screen. In an embodiment, the noise protection filter is attached to the microphone. Further, in some embodiments, the noise protection filter is built inside the microphone.

In some embodiments, the microphone is a condenser microphone. In an embodiment, the microphone is a dynamic microphone.

In some embodiments, the one or more computing devices includes phone, tablet, or other portable computing devices. Further, the one or more computing devices can be installed one or more music software including one or more digital platform applications.

In some embodiments, the one or more reflection filters include one or more utility microphone shield. Further, in an embodiment, the one or more reflection filters include acoustic materials to dampen and absorb sound wave reflections.

In some embodiments, the microphone is disposed between the one or more reflection filters and one or more computing devices. In other embodiments, the microphone is disposed between the one or more reflection filters and the noise protection filter.

In some embodiments, the one or more connectors are universal connectors.

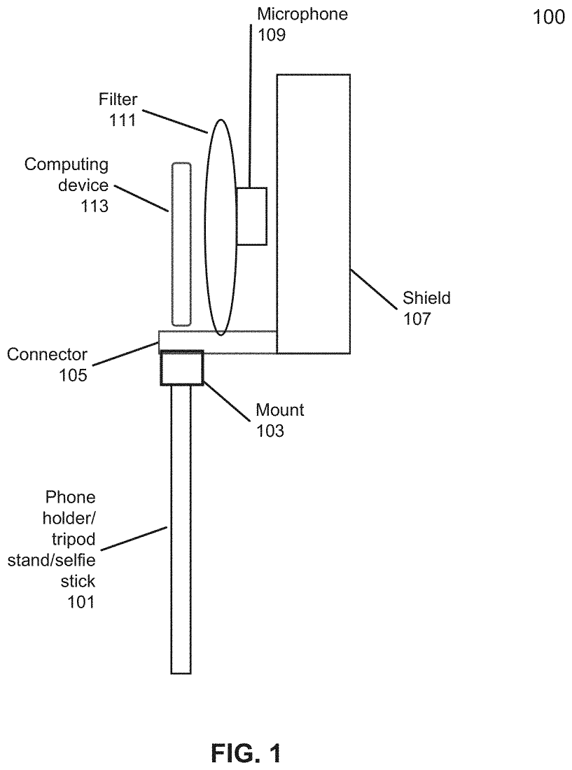

FIG. 1 is a side view of an example of a hand held mobile studio and booth system according to an embodiment of the application. In this example, FIG. 1 shows a side view of at least a portion of hand held mobile studio and booth system 100. Referring to FIG. 1, according to one embodiment, hand held mobile studio and booth system 100 includes cell phone with digital platform application 113, microphone 109, pop filter 111 to reduce popping sounds caused by fast moving air on the microphone, a Bluetooth transmitter (not shown), universal mount 105, utility microphone shield 107 to reduce background noise by preventing sound waves reflection, and phone holder/tripod stand/selfie stick 101 coupled with universal mount 103 to hold above components (e.g., universal mount 105, utility microphone shield 107, microphone 109, pop filter 111, cell phone 113) through universal connector(s) 105.

In particular, in some embodiments, hand held mobile studio and booth system 100 includes phone holder/tripod stand/selfie stick 101. For example, stick 101 can be a selfie stick which is the foundation for the unit as it provides stability balance and support while held in the palm as well as for the support for all studio components (e.g., universal mount 105, utility microphone shield 107, microphone 109, pop filter 111, cell phone 113) according to some embodiments of the application.

Further, in some embodiments, stick 101 can support can include a retractable tri-pod which allows the user to extend and transform the recording booth into a microphone stand. Additionally, stick 101 can be equipped with a ball joint for swivel action between the hardware and the handle providing a more stable and comfortable user experience.

Furthermore, in some embodiments, hand held mobile studio and booth system 100 includes utility microphone shield 107. For example, shield 107 includes reflection filters according an embodiment of the application. That is, utility microphone shield 107 acts as a filter by reducing unwanted background noise preventing sound waves reflection to best isolate recording vocals. By isolating the artists' voice, microphone 109 will be more effective in absorbing vocals. In some embodiments, shield 107 has dense, uneven acoustic materials surrounding microphone 109 to dampen and absorb sound wave reflections.

Further, eliminating unwanted ambiance or noise makes vocal recordings more dry, clear, and balanced, while simultaneously decreasing a users' probability of having vocal discoloration. Typically, vocal isolation shields are employed in casual environments and improve the acoustic quality of a user's recordings with minimal equipment.

Further, in some embodiments, hand held mobile studio and booth system 100 includes microphone 109. For example, having a good microphone provides better audio quality. In addition, system 100 may include several types of microphones including dynamic microphones and condenser microphones. The present disclosure is a Hand-Held Studio and Booth which minimizes background noise with a dynamic microphone.

Microphones typically have a coil of wire that is surrounded by a magnet, which is connected to a diaphragm that vibrates upon incoming sound waves. When sound waves hit the diaphragm, the coil will move back and forth past the magnet, generating a current which creates an audio signal.

In other embodiments, hand held mobile studio and booth system 100 includes a mic cast. Microphone 109 can be a mic cast, a simple device that doesn't require any setup or special equipment to use. Microphone 109 plugs into the headphone jack a computing device 113, such as an iPhone/iPod or an Android device, acting as the external mic to the mobile device. Users can use microphone 109 by plugging it into a computing device to record voice memos, record videos, or talk on speakerphone.

Furthermore, in some embodiments, hand held mobile studio and booth system 100 includes pop filter 111. For example, filter 111 (or pop screen, pop shield) is a 5×4 black metallic magnetic feature pop screen that is secured to the unit formally. This equipment is used as a noise protection filter for these devices are typically used in recording studios.

In some embodiments, pop screen 111 serves to reduce or eliminate popping sounds caused by the mechanical impact of fast-moving, explosions of air on the microphones from plosives during recorded speech and singing. For example, popping sounds occur particularly in the pronunciation of aspirated plosives (such as the consonants “T” or ‘P’ in the English word “Popping”). The popping sound recorded by a microphone has two components. First, high-frequency components are from air moving past the grille or other parts of the microphone body. Secondly, the low-frequency component is from air impacting the diaphragm. Mechanical and electrical saturation (e.g., clipping) can also play a role depending on the amount of headroom designed into these systems.

Further, in some embodiments, hand held mobile studio and booth system 100 includes cell phone 113 with digital platform application. For example, computing device 113 can be a phone such as Android Cellphone or Apple Cellphone may include the operating system. Further, computing device 113 can be a tablet such as Android Tablet or iPad based on user preference. Users have freedom over choosing their personal devices or music software apps. Users can attach their device to the Hand-held Mobile Studio and Booth 100.

Furthermore, in some embodiments, computing device 113 may include a screen to display in the photograph for user's personal preference by pre-downloaded music software such as Google's “Google Play Store” which provides the platform for the music productions.

Further, in some embodiments, hand held mobile studio and booth system 100 includes a Bluetooth transmitter (not shown). For example, through the Bluetooth transmitter technology, it allows the artists to access enriched digital sounds through their own personal connected devices and other platform connected devices. Independent Bluetooth transmitters can be used in place of traditional manufacturing headsets or wireless Bluetooth headsets with recordings through pre-installed software such as Android device's pre-installed Bluetooth tech software. It is important that the sound must travel and be processed through the condenser microphone first before exiting the output which leads to the Bluetooth transmitter. This mechanism overrides microphone 109 on the manufacturer Bluetooth headset, therefore dividing the vocal line from the soundtrack, allowing the dual transmission of the vocals to two separate devices such as a Bluetooth headset or Bluetooth speaker. In some embodiments, one or more connectors 105 can be universal connectors.

It should be noted that these aforementioned components are considered an important aspect and requirement in the production of high quality studio recordings, as well the options and characteristics should be considered when choosing microphone 109, reflection filter 107 and pop screen 111 designed based on a type of vocal recordings.

Further, by using an acoustic shield with a large absorptive filter that curves around microphone 109, there will be greater vocal isolation that allows users' optimal protection from reflected frequencies and background ambiance. Also, the Mic Size also matters. If the filter is too small, background noise and reflections might compromise the quality of recording. Therefore, taller microphone will require a larger surface arc.

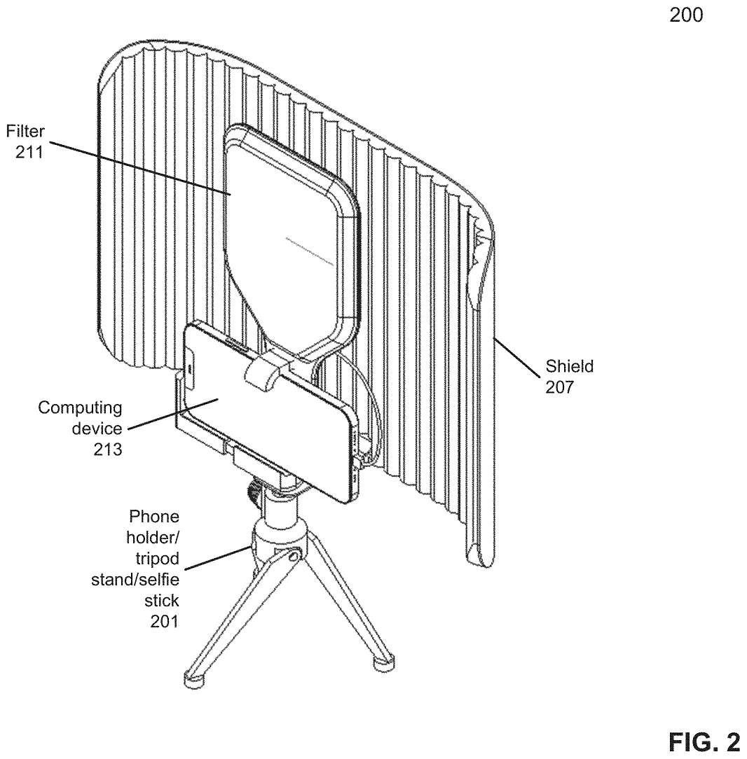

FIG. 2 is another side view (microphone not shown) of an example of a hand held mobile studio and booth system 200 according to an embodiment of the application. For example, in FIG. 2, a hand held mobile studio and booth system 200 includes a stick 201 coupled with a universal mount to hold one or more components through one or more connectors. For example, the one or more components include one or more computing devices 213, a microphone (not shown), noise protection filter 211 to reduce popping sounds caused by fast moving air on microphone, one or more electronic devices (not shown) to allow dual transmission, and one or more reflection filters (217) to reduce background noise by preventing sound waves reflection.

In some embodiments, the stick 201 is swayable for a variety angles to provide stability and balance to support the one or more components (e.g., computing devices 213, a microphone (not shown), noise protection filter 211, one or more electronic devices (not shown), shield 217) while the stick is held by a user. For example, an angle (e.g., 30 degrees, 60 degrees, 90 degrees) of the variety angles is adjustable by the user according to an embodiment of the application. Further, in some embodiments, the stick 201 has a ball joint for a swivel action.

In some embodiments, stick 201 is extendable. In an embodiment, stick 201 is retractable. In other embodiments, stick 201 has a retractable tri-pod feature to allow the user to extend and transform into a microphone stand feature.

In some embodiments, the one or more electronic devices (not shown in FIG. 2) includes a Bluetooth transmitter to allow dual transmission to two or more devices including one or more of headset and speaker.

In some embodiments, noise protection filter 211 is a pop screen. In an embodiment, noise protection filter 211 is attached to the microphone (not shown in FIG. 2). Further, in some embodiments, noise protection filter 211 is built inside the microphone.

In some embodiments, the microphone is a condenser microphone. In an embodiment, the microphone is a dynamic microphone.

In some embodiments, the one or more computing devices 213 includes phone, tablet, or other portable computing devices. Further, one or more computing devices 213 can be installed one or more music software including one or more digital platform applications.

In some embodiments, one or more reflection filters 207 include one or more utility microphone shield. Further, in an embodiment, one or more reflection filters 207 include acoustic materials to dampen and absorb sound wave reflections.

In some embodiments, the microphone is disposed between one or more reflection filters 207 and one or more computing devices 213. In other embodiments, the microphone is disposed between one or more reflection filters 207 and noise protection filter 211.

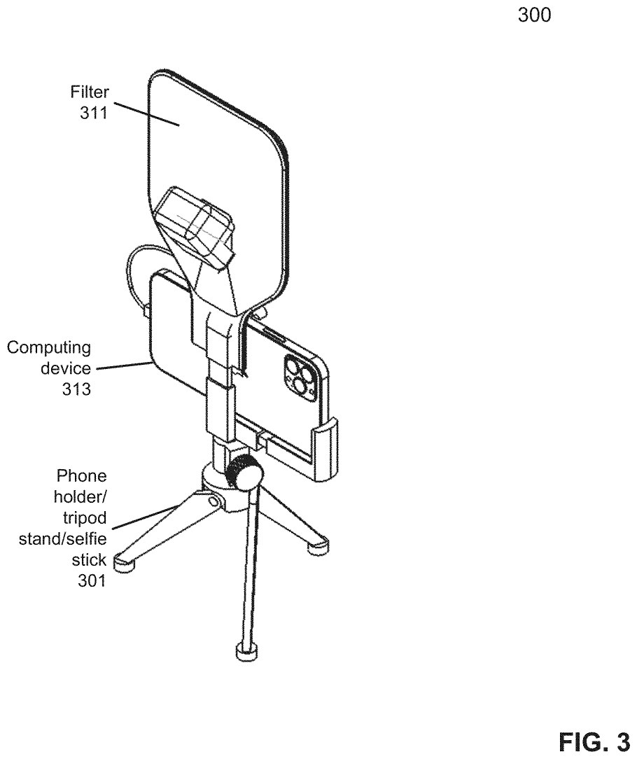

FIG. 3 is a side view (microphone shield now shown) of an example of a hand held mobile studio and booth system according to an embodiment of the application. For example, in FIG. 3, a hand held mobile studio and booth system 300 includes a stick 301 coupled with a universal mount to hold one or more components through one or more connectors. For example, the one or more components include one or more computing devices 313, a microphone (not shown), noise protection filter 311 to reduce popping sounds caused by fast moving air on microphone, one or more electronic devices (not shown) to allow dual transmission, and one or more reflection filters (not shown) to reduce background noise by preventing sound waves reflection.

In some embodiments, stick 301 is swayable for a variety angles to provide stability and balance to support the one or more components (e.g., computing devices 313, a microphone (not shown), noise protection filter 311, one or more electronic devices (not shown), shield (not shown)) while stick 301 is held by a user. For example, an angle (e.g., 30 degrees, 60 degrees, 90 degrees) of the variety angles is adjustable by the user according to an embodiment of the application. Further, in some embodiments, the stick 301 has a ball joint for a swivel action.

In some embodiments, stick 301 is extendable. In an embodiment, stick 301 is retractable. In other embodiments, stick 301 has a retractable tri-pod feature to allow the user to extend and transform into a microphone stand feature.

In some embodiments, the one or more electronic devices (not shown in FIG. 3) includes a Bluetooth transmitter to allow dual transmission to two or more devices including one or more of headset and speaker.

In some embodiments, noise protection filter 311 is a pop screen. In an embodiment, noise protection filter 311 is attached to the microphone (not shown in FIG. 3). Further, in some embodiments, noise protection filter 311 is built inside the microphone.

In some embodiments, the one or more computing devices 313 includes phone, tablet, or other portable computing devices. Further, one or more computing devices 313 can be installed one or more music software including one or more digital platform applications.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A hand held mobile studio and booth system, comprising:
a stick coupled with a universal mount to hold one or more components through one or more connectors, wherein the one or more components include:
one or more computing devices,
a microphone,
a noise protection filter to reduce popping sounds caused by fast moving air on the microphone,
one or more electronic devices to allow dual transmission, and
one or more reflection filters to reduce background noise by preventing sound waves reflection.

2. The system of claim 1, wherein the stick is swayable for a variety angles to provide stability and balance to support the one or more components while the stick is held by a user.

3. The system of claim 2, wherein an angle of the variety angles is adjustable by the user.

4. The system of claim 2, wherein stick has a ball joint for a swivel action.

5. The system of claim 1, wherein the stick is extendable.

6. The system of claim 1, wherein the stick is retractable.

7. The system of claim 1, wherein the stick has a retractable tri-pod feature to allow the user to extend and transform into a microphone stand feature.

8. The system of claim 1, wherein the one or more electronic devices includes a Bluetooth transmitter to allow dual transmission to two or more devices including one or more of headset and speaker.

9. The system of claim 1, wherein the noise protection filter is a pop screen.

10. The system of claim 1, wherein the noise protection filter is attached to the microphone.

11. The system of claim 1, wherein the noise protection filter is built inside the microphone.

12. The system of claim 1, wherein the microphone is a condenser microphone.

13. The system of claim 1, wherein the microphone is a dynamic microphone.

14. The system of claim 1, wherein the one or more computing devices includes phone, tablet, or other portable computing devices.

15. The system of claim 1, wherein the one or more computing devices can be installed one or more music software including one or more digital platform applications.

16. The system of claim 1, wherein the one or more reflection filters include one or more utility microphone shield.

17. The system of claim 1, wherein the one or more reflection filters include acoustic materials to dampen and absorb sound wave reflections.

18. The system of claim 1, wherein the microphone is disposed between the one or more reflection filters and one or more computing devices.

19. The system of claim 1, wherein the microphone is disposed between the one or more reflection filters and the noise protection filter.

20. The system of claim 1, wherein the one or more connectors are universal connectors.
